(19) United States
(12) Patent Application Publication
(10) Pub. No.: US 2002/0122230 A1
(43) Pub. Date: Sep. 5, 2002

(54) Hybrid RF and optical wireless communication link and network structure incorporating it therein

(76) Inventors: Hossein Izadpanah, Thousand Oaks, CA (US); Gregory L. Tangonan, Oxnard, CA (US)

Correspondence Address: Tope-McKay & Associates, 23852 Pacific Coast Highway #311, Malibu, CA, 90265, US

(21) Appl. No.: 09/800,917

(22) Filed: Mar. 5, 2001

(51) Int. Cl. H04B 10/00

(52) U.S. Cl. 359/145; 359/172

(57) ABSTRACT

A hybrid wireless link 100 of the present invention provides a gateway between two wired data systems 102, such as backbone fiber networks, and comprises a laser portion 104, a radio frequency portion 106, and a controller 108. The laser portion 104 and the radio frequency portion 106 provide, side-by-side and point-to-point, a free-space optical wireless link and a radio frequency wireless link. The controller 108 may be designed to respond to atmospheric conditions based on environmental information such as weather tables or the transmit/receive power of the laser portion 104 and the radio frequency portion 106, with signal switched between the laser portion 104 and the radio frequency portion 106 with a binary switch or a variety of latched levels using an incremental switch. The hybrid wireless link 100 may also use multiple channels and may be configured for a variety of networks including multi-channel ring topologies.

### TECHNICAL FIELD

The present invention relates to broadband communication systems, and more particularly to wireless communication links within broadband networks.

### BACKGROUND

Gigabit data transport and processing technologies are required to respond to the needs of present and future information distribution and high-speed Internet applications. Fiber optics technology has matured as a method of data transport, allowing information exchange rates at terabit levels, and potentially beyond. However, in areas lacking fiber infrastructure, wireless technologies employing radio frequency and free-space laser links are the medium of choice for broadband wireless networking. In the wireless domain, and particularly in radio frequencies, propagation effects, atmospheric degradation, and environmental factors limit the maximum communication channel speed/data rates, link performance, and availability.

Typical bit rates for radio frequency systems are in the range of a few megabits per second for mobile applications and in the range of a few hundred megabits per second for fixed wireless links. Even at these relatively low data rates, the links typically suffer from high error rates and low quality of service performance, both typically several orders of magnitude worse than with fiber optics.

In particular, wireless optical links suffer degradation due to fog and other atmospheric conditions that severely attenuate the wireless signal and block the transmission of light from link to link, while radio frequency links suffer degradation due to rain and other particulate matter between links, as well as multipath effects caused by signal reflection.

Therefore, it would be desirable to provide a communication link system incorporating a hybrid mixture of optical and radio frequency links to provide communication link redundancy, to cope with signal degradation, and to mitigate the particular atmospheric limitations of each.

### SUMMARY

The present invention provides, in one embodiment, a node incorporating hybrid radio frequency and optical wireless communication links, wherein the node comprises a laser portion for transmitting data; a radio frequency portion for transmitting data; a data receiver for receiving data from a data source; and a controller configured to receive data from a data source and connected with the laser portion and the radio frequency portion to allocate the portions of the data to be transmitted through the laser portion and the radio frequency portion.

In another embodiment, the node further incorporates a controller that is configured as a binary switch such that the data is transmitted exclusively through either one of the laser portion and the radio frequency portion.

In yet another embodiment, the node incorporates a controller configured to receive environmental information, and the controller based on the environmental information adjusts the portions of the data to be transmitted through the laser portion and the radio frequency portion.

In still another embodiment, the laser portion is configured to both transmit and receive and the radio frequency portion is configured to both transmit and receive.

In another embodiment, the laser portion and the radio frequency portion are configured to transmit in multiple channels.

In a further embodiment, the the controller is configured to monitor the transmit and receive strengths, wherein the portions of the data to be transmitted through the laser portion and the radio frequency portion are adjusted by the controller based on their transmit and receive strengths.

In yet another embodiment, the controller includes a plurality of latches and a logic device, where the plurality of latches and the logic device operate to provide adjustment levels for the portions of the data to be transmitted through the laser portion and the radio frequency portion. Thus, the overall bandwidth of the hybrid radio frequency and optical wireless communication link may be optimized for a particular set of weather conditions.

In a still further embodiment of the present invention, the laser portion and the radio frequency portion have aggregate transmit and receive strengths, and the controller is configured to monitor the aggregate transmit and receive strengths, wherein the portions of the data to be transmitted through the laser portion and the radio frequency portion are adjusted by the controller based on their transmit and receive strengths.

In another embodiment of the present invention, each transmission channel has a transmit and receive strength, and wherein the controller is configured to monitor the transmit and receive strength of each channel; and the channels of the data to be transmitted through the laser portion and the radio frequency portion are determined by the controller based on their transmit and receive strengths.

In yet another embodiment of the present invention, the laser portion and the radio frequency portion are configured to transmit and receive in tandem, so that the node may be configured to provide a hybrid serial link to permit tailored radio frequency or optical network connections.

In a further embodiment of the present invention, an optical reflector is used to deflect transmissions from the laser portion in order to work around fixed objects in the environment, so that the node may be used to extend a network and the laser portion can maintain communication without the need for a strict line-of-site connection.

In another embodiment of the present invention, a network is presented, incorporating hybrid radio frequency and optical wireless communication links, with the network comprising a plurality of nodes, with each node including a laser portion for transmitting data; a radio frequency portion for transmitting data; a data receiver for receiving data from a data source; and a controller configured to receive data from a data source and connected with the laser portion and the radio frequency portion to allocate the portions of the data to be transmitted through the laser portion and the radio frequency portion. Each node in the network may be configured in any of the embodiments previously discussed.

In a further embodiment of the network, at least a portion of the network may be configured as a ring topology, and more specifically as a SONET ring.

### BRIEF DESCRIPTION OF THE DRAWINGS

FIG. 1(a) is a block diagram showing an embodiment of the hybrid wireless link of the present invention with a laser portion, a radio frequency portion, and a controller;

FIG. 1(b) is a block diagram showing several modes of operation of the laser portion and the radio frequency portion of an embodiment of the hybrid wireless link of the present invention, wherein the hybrid wireless link includes a binary switch in the controller;

FIG. 2 is a block diagram showing a multi-channel embodiment of the hybrid wireless link of the present invention;

FIG. 3(a) is a block diagram showing the general form of the controller of the hybrid wireless link of the present invention;

FIG. 3(b) is a block diagram showing an example of the controller of the hybrid wireless link of the present invention adapted to function as a binary switch;

FIG. 3(c) is a block diagram showing an example of the controller of the hybrid wireless link of the present invention adapted for multi-channel use with either sub-carrier modulation or wavelength division modulation;

FIG. 3(d) is a block diagram showing an example of the controller of the hybrid wireless link of the present invention adapted for use with a series of latches and a logic unit to allow partitioning for various combinations of signal transmission capacity between the laser portion and the radio frequency portion;

FIG. 4 is an illustration showing an embodiment of the present invention used as a tandem link for extending network reach and used in conjunction with a reflector (mirror) for projecting around a building;

FIG. 5(a) is an illustration showing a typical solution to the breaking of a link in a ring closure with a wireless interconnection to bridge a link in a ring-type network; and

FIG. 5(b) is an illustration showing the use of the hybrid wireless link of the present invention as an improved solution to the breaking of a link in a ring-type network.

### DETAILED DESCRIPTION

The present invention provides a method and apparatus that incorporates a wireless optical link and a radio frequency link to provide redundant and backup support for a communication system. The invention assists in overcoming the specific limitations of individual wireless optical and radio frequency links by providing a hybrid link in order to increase communication connectivity and reliability. The following description, taken in conjunction with the referenced drawings, is presented to enable one of ordinary skill in the art to make and use the invention and to incorporate it in the context of particular applications. Various modifications, as well as a variety of uses in different applications, will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein. Furthermore it should be noted that unless explicitly stated otherwise, the figures included herein are illustrated diagrammatically and without any specific scale, as they are provided as qualitative illustrations of the concept of the present invention.

The following terms are used throughout the description, and in some cases in the claims, of the present invention. The glossary below is provided as a guide to assist in providing an effective disclosure regarding the essence of the invention.

### Glossary

Node: Nodes, in the context of the present invention, indicate network components, for example, general purpose computers, terminals, routers, etc. that incorporate the hybrid wireless link for use in data communications.

Data Systems: Data systems, in the context of the present invention, are computing systems, storage systems, networks, network components, etc., which provide the data that is transmitted via the hybrid wireless links.

Radio Frequency: Radio frequency, in the context of the present invention, includes the entire spectrum of radio frequency radiation, including millimeter wave, microwave, and other frequencies.

Optical: Optical, in the context of the present invention, includes both visible and invisible light of various wavelengths that can be used to transmit data. In particular, the present invention uses laser links to provide data communications.

Environmental information: Environmental information, in the context of the present invention, indicates any information that may be used to determine whether the controller of the hybrid wireless link should route transmissions through the radio frequency portion or the laser portion. Thus, environmental information, in a broad sense, can be determined by such methods as from look-up tables, forecasts, from weather equipment connected with the controller, or from monitoring the real-time transmit/receive power of the radio frequency and laser portions of the hybrid wireless link.

### Introduction

The present invention provides a hybrid radio frequency and optical wireless communication link suitable for wireless access, distribution, and backbone network interconnections. The hybrid solution provides enhanced wireless network reliability and an increased network aggregate capacity under all-weather and diverse atmospheric conditions. Other advantages and capabilities of the hybrid wireless link include higher channel rates compared with a radio frequency link alone, higher wireless network availability, link failure accommodation, selective traffic routing, and relatively high security links. Several specific embodiments of the present invention are provided as guides to an understanding of particular applications in which it may be used. The basic hybrid link will be discussed incorporating, in a first example, a binary switch, which steps the traffic load from all-radio frequency to all-optical and vice-versa, and in a second example, a gradual stepping mechanism, which steps, incrementally, between an all-radio frequency and all-optical and vice-versa. Next, an embodiment of the hybrid link tailored for multi-channel (multiple user) operation will be described. Then, a discussion of the mechanism that provides for switching and stepping between the optical portion and the radio frequency portion is provided. Finally, the present invention will be discussed in the context of various network architectures including the use of the above protection techniques to close, wirelessly, ring network topologies and as a means for extending the reach of typical radio frequency coverage links.

### Basic Hybrid Link

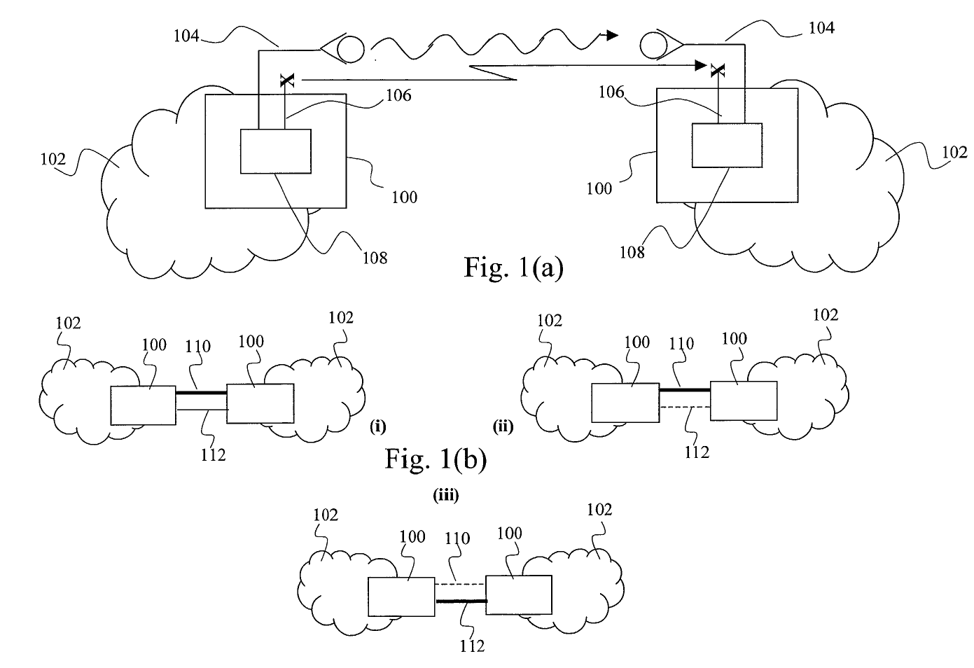

A schematic diagram of an embodiment of the hybrid radio frequency and optical wireless communication link of the present invention is presented in FIG. 1(a). In the figure, two hybrid wireless links 100 are shown in communication, providing a gateway between two wired data systems 102. Specifically, in FIG. 1(a), the data systems 102 represent backbone fiber networks, although as defined above, the data systems 102 may take the form of any systems or nodes between which wireless communication is desirable. A hybrid wireless link 100 of the present invention includes a laser portion 104, a radio frequency portion 106, and a controller 108. The laser portion 104 and the radio frequency portion 106 provide, side-by-side and point-to-point, a free-space optical wireless link and a radio frequency wireless link, respectively.

The laser portion 104 of the hybrid wireless link 100 provides a relatively secure and high bandwidth connection, whereas the radio frequency portion 106 is slower and more susceptible to interference, multipath problems, and interception. However, despite its apparent advantages, the laser portion 104 provides poor performance when the atmosphere is filled with relatively small interfering particles such as water vapor in the case of fog. On the other hand, the laser portion 104 is relatively unaffected by the presence of larger particles such as rain and snow (the effect is dependent on particle size). Conversely, the radio frequency portion 106, despite its generally lower performance, functions well when relatively small interfering particles are present and poorly when larger particles are present. These characteristics make the laser portion 104 and the radio frequency portions 106 good complements to each other for providing a redundant and weather protective system that is operative over a broad range of atmospheric conditions.

In addition to compensating for differing atmospheric conditions, the hybrid wireless link 100 of the present invention also provides a fail-safe system that is remains effective should either one of the laser portion 104 or the radio frequency portion 106 fail. This redundancy is especially useful for ensuring that critical links in a network remain operative.

It is also important to note that depending on the particular configuration, an individual hybrid wireless link 100 could be configured to transmit only, to receive only, or to both transmit and receive communications to and from another hybrid wireless link 100.

The controller 108 of the hybrid wireless link 100 may be configured as a binary switch, which allows either the laser portion 104 or the radio frequency portion 106 to be active at a given time, but not both. For example, assuming that the laser portion 104 is transmitting information, and a specific event such as equipment failure in one of the portions or a particular atmospheric condition occurs, the controller 108 could re-route communications through the radio frequency portion 106 to minimize the chance of total failure. On the other hand, the controller 108 could also be configured to provide a gradual stepping between the portions in order to maximize the operating bandwidth of the hybrid wireless link 100. Because the laser portion 104 provides a much higher rate of communication than the radio frequency portion 106, it may not be desirable to switch exclusively from the laser portion 104 to the radio frequency portion 106 because of the sharp drop in bandwidth. This is in keeping with the fact that the impact of weather on the laser portion 104 is generally a gradual degradation of the link performance, and the link may still be used with a lower traffic load and a lower operating speed. Therefore, in order to provide the maximum bandwidth possible for a given environmental condition, it is desirable to step incrementally from the laser portion 104 to the radio frequency portion 106, and vice-versa. For example, in the case of fog, the laser portion 104 loses its effectiveness. However, its level of effectiveness depends on the thickness of the fog.

For low levels of thickness, the laser portion 104 can still transfer data much faster than the radio frequency portion 106. Therefore, the radio frequency portion 106 can be used as a supplement to the laser portion 104 until the laser portion 104 is no longer able to meet the desired quality of service level. Thus, because of its redundancy, the hybrid wireless link 100 of the present invention is able to maintain much greater bandwidth in adverse conditions than that of a typical individual wireless link.

The controller 108 incorporates environmental information in order to determine whether it should use the laser portion 104, the radio frequency portion 106, or a combination of both. The environmental information can be obtained in several ways, including by receiving external weather forecasts and by monitoring power reduction based on feedback from another hybrid wireless link 100. External environmental information forecasts can be obtained from a previously measured, seasonally averaged, and calibrated look-up table, they can incorporate daily weather condition information, or they can be developed internally through the use of weather measuring instruments attached to the hybrid wireless link 100. On the other hand, two hybrid wireless links 100 in communication can make deductions regarding the weather by continually monitoring the transfer rate of, errors in, and transmission power received by, each of the laser portion 104 and the radio frequency portion 106. Based on the characteristics of the communication of a particular portion, a deduction may be made about the environment. For example, since it is known that the laser portion 104 is highly susceptible to fog, while the radio frequency portion 106 is susceptible to rain, if there is a sharp drop in the communication ability of the laser portion 104 with relatively small drop in that of the radio frequency portion 106, it may be assumed that fog is in the air, and the communication may be re-routed through the radio frequency portion 106. As the fog begins to lift, and a greater power level is detected from the laser portion 104, the controller 108 may begin to route more of the communication through the laser portion 106. In this example, if the controller 108 is configured as a binary switch, its activation may be conditioned upon a specific environmental threshold.

It is important to note that the two portions may be kept active at all times, even though they are not necessarily both transmitting data. It may be desirable to keep both portions active so that the received power of each may be monitored in order to determine when to begin utilizing them for communications.

In situations where a combination of regular or non-secure transmissions and secure transmissions take place, it may be desirable to have the secured transmissions key sent only via the laser portion 104 because its transmissions are much less prone to interception than those of the radio frequency portion 106. Thus, during times when the laser portion 104 is inactive, only transmissions of the regular or non-secure type would be allowed, and secure transmissions would either be delayed or transmitted in another secure fashion.

A summary of the different states of a communication link formed by hybrid wireless links 100 of the present invention is shown in FIG. 1(b), with a laser communication link 110 and a radio frequency communications link 112. The dashed lines represent failed links and the solid lines represent active or standby links. In the case of a binary controller 108, there are three possible scenarios. In the first scenario, labeled (i), both the laser portion 104 and the radio frequency portion 106 are active. In this case, although both the laser communication link 110 and the radio frequency communication link 112 are functional, the radio frequency portion 106 is likely to be in a standby state because its transmission rate is very small relative to that of the laser portion 104. In the second scenario, labeled (ii), the laser portion 104 is inactive, or incapable or transmitting, while the radio frequency portion 106 is active, as would be the case in a heavy fog. In this case, all communication occurs via the radio frequency link 112. In the third scenario, labeled (iii), as would be the case in rain or snow, the radio frequency portion 106 is inactive and the laser portion 104 is active. The three states of the hybrid wireless links 100 just described represent the three possibilities when a binary controller 108 is used. However, in the case of a gradual stepping mechanism, these states represent extreme possibilities, with actual states typically falling somewhere in between.

Depending on the particular embodiment, hybrid wireless links 100 can also be configured to provide an asymmetric communication service, utilizing, for example, a laser portion 104 to provide higher speed downstream capacity and utilizing a radio frequency portion 106 to provide lower speed upstream capacity, or vice-versa. In particular, embodiments of this sort could be highly suitable for adaptive and negotiated bandwidth in either direction.

### Multi-channel Hybrid Wireless Link

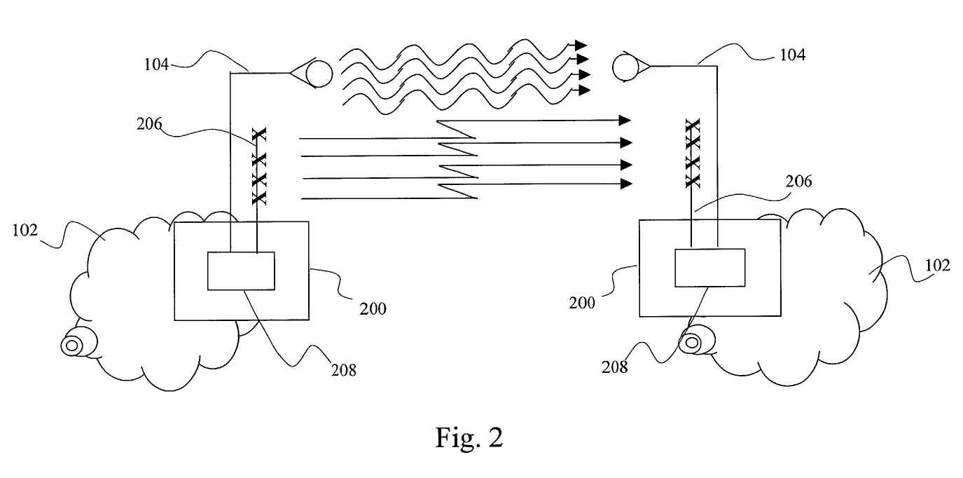

The protection and link restoration functional capability of the hybrid wireless link 100 discussed above can easily be expanded to a 1:N protection scheme, where N represents the number of redundancies desired within the system, and to multi-channel communication systems. An example of a multi-channel hybrid wireless link 200 is shown in FIG. 2. In this embodiment, a laser portion 104 and a multi-channel radio frequency portion 206 are shown. The radio frequency portion 206 incorporates multiple transmitters and/or receivers, each at a different frequency, configured to operate in multiple bands; non-limiting examples of which include Cellular, PCS, NII, millimeter wave, microwave, etc. A single laser portion 104 can operate to provide collective multi-channel communications. The optical signal, in this case, will carry either multiple sub-carrier modulated (SCM) digital and/or analog channels pairing with their radio frequency counterparts or corresponding wavelength division multiplexed (WDM) channels. The SCM and WDM techniques are well known in the art, and fiber optic components and technologies are available for radio frequency carriers well above the presently operating millimeter wave wireless bands.

In a multi-channel embodiment, the controller 208 may receive environmental information that indicates that there will be a greater effect on certain channels than on others. As a result, the controller 208 can provide a finer level of control over the switching or stepping between the laser portion 104 and the radio frequency portion 206 by transmitting those radio frequency channels likely to be most affected by the environment through the laser portion 104 as an optical signal, or conversely, by transmitting the optical wavelengths likely to be most affected by the environment through the radio frequency portion 206. The details of the controller 208 will be provided below.

### The Controller: Switching Between the Laser Portion and the Radio Frequency Portion

The controller 108 and 208 may be embodied in many specific ways, including as a simple switch and as a latched system that provides an incremental steping between the laser portion 104 and 204 and the radio frequency portion 106 and 206. The embodiments of the controller 108 and 208, presented below are readily adaptable to both single and multi-channel hybrid wireless links. It is important to note, however, that these embodiments are considered to be non-limiting examples of possible configurations for the controller 108 and 208, as many other possible configurations can readily be derived.

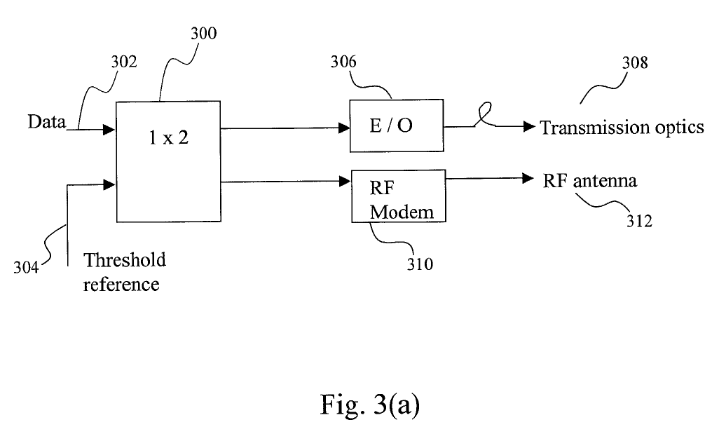

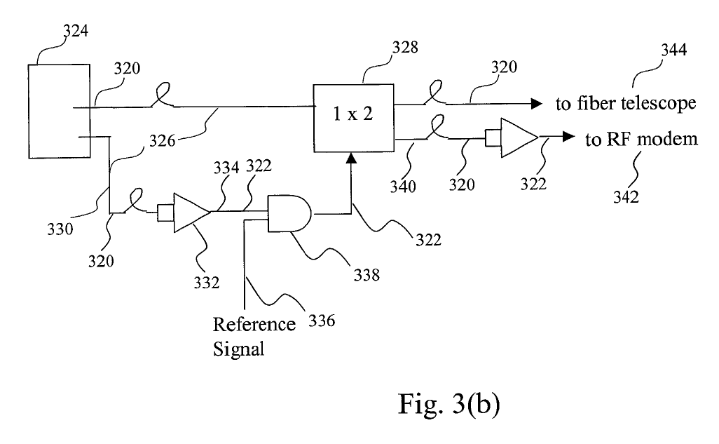

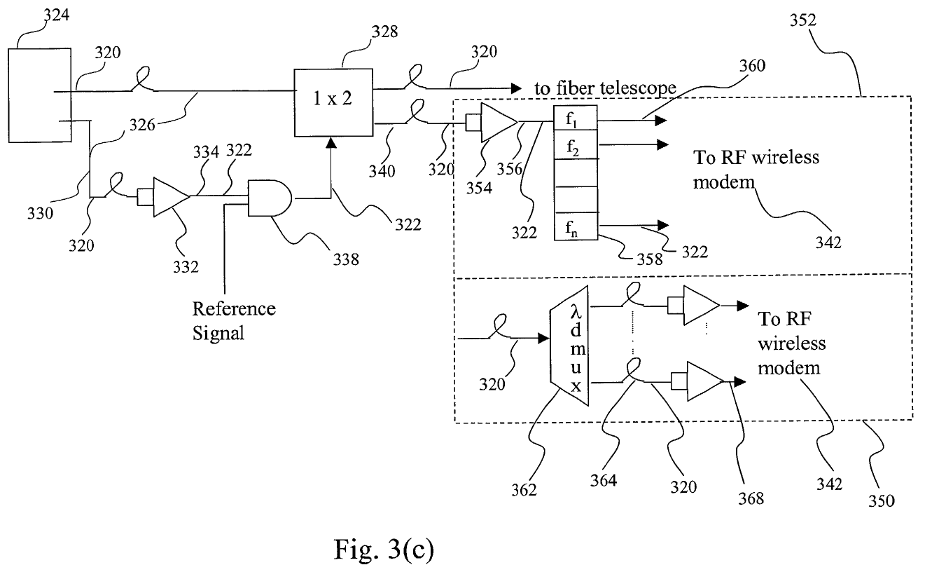

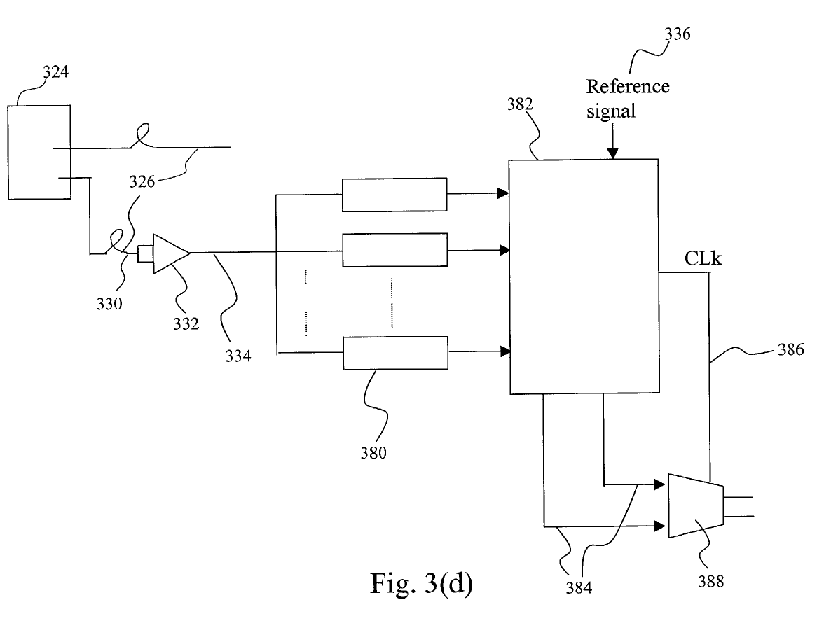

In general, the controller 108 and 208 is configured as shown in FIG. 3(a). The controller 108 and 208 includes a 1×2 switch 300, which receives a data signal 302 and a threshold reference signal 304. The data signal 302 includes the data to be transmitted by the hybrid wireless link 100. The threshold reference signal 304 is used to determine whether to send the signal through the laser portion 104 or the radio frequency portion 106 and 206, or a combination thereof, and can be generated from weather-related data including from current environmental information, from weather information from look-up tables, or from monitoring the transmission power levels of the laser portion 104 and the radio frequency portion 106 and 206. The outputs of the switch 300 are attached to an electro/optical converter 306 connected with the transmission optics 308, and to an RF modem 310 connected with the radio frequency antenna 312. It is important to note that although in this case, the data signal 302 is assumed to be an electrical signal, with appropriate converters, the controller 108 and 208 is easily adaptable for receipt of an optical signal.

Multi-channel versions of the controller 108 and 208 can be used with time-division multiplexing, sub-carrier modulation, wavelength division modulation, and other techniques. In particular, with sub-carrier modulation and wavelength division modulation, channel filters or color filters are employed in the assembly and disassembly of the signal into its components. The general architecture presented in FIG. 3(a) is readily adaptable for to these ends. The switch 300, can be configured to provide switching on a block basis or on a channel-by-channel basis. Switching on a channel-by-channel basis can help to provide a tighter optimization based on current transmission conditions.

It is important to note that many of the switching functions of the controller 108 and 208 may be implemented using a field programmable gate array (FPGA), which is highly controllable, and which can allow the number of channels to be varied for a given situation. Asynchronous transfer mode (ATM) switching technology may also be employed for this purpose.

In addition to single and multi-channel versions of the controller 108 and 208, an incremental switch 300 may be employed in order to provide different levels of shifting between the laser portion 104 and the radio frequency portion 106 and 206. By employing multiple levels, the system is able to optimally conform to varying weather conditions. This version of the controller 108 and 208 employs a multilevel latch system that responds to varying levels of the threshold reference signal 304. The FPGA generates a component clock signal, and depending on which latch is active, prepares different numbers of sub-channel combination loads for the laser portion and radio frequency portion for transmission. The FPGA or ATM, under control of the latches will generate a combination of laser and radio frequency signals to accommodate a particular set of atmospheric conditions.

Below, three specific examples of embodiments of the controller 108 and 208 will be provided in order to assist in providing a better understanding of its operation. It is important to note that the controller 108 and 208 may be configured in many ways, and is not to be considered limited to the examples provided below.

### Controller Example 1

A component overview of a single channel switch embodiment of the controller 108 and 208 is provided in FIG. 3(b). This controller is tailored for the embodiment of the invention shown in FIG. 1, and therefore, is applicable to the controller referenced as 108. The controller 108 includes a plurality of optical fibers 320 as well as a plurality of wire connections 322. A gateway portion of the controller 324 is connected with the data system 102 (as shown in FIG. 1) to receive a signal for transmission 326. The major portion of the signal for transmission 326 is provided to a 1×2 electrical/optical switch 328, while a small tapped portion 330 of the signal for transmission is provided to a photodiode 332 for conversion to an electrical signal 334. The electrical signal 334 and a reference signal 336 obtained from weather conditions, measured power, or a look up table are provided to a logical AND gate 338 for comparison. Optionally, this check allows the controller 108 to compare the current transmission power to that required to push the optical signal across to the next hybrid wireless link 100. Alternatively, it allows the controller 100 to utilize a threshold power level derived from environmental information in order to control whether the laser portion 104 or the radio frequency portion 106 and 206 is employed. If the current transmission power is too small or if the weather exceeds a certain threshold, the electro /optical switch 328 will cause the signal for transmission 326 to go into a second leg of the output fiber 340 en route to a radio frequency modem 342 in preparation for transmission. Otherwise, if the hybrid wireless link's 100 current transmission power is sufficiently above the set threshold/reference level, the signal for transmission 326 will go directly to a laser telescope 344 for transmission.

### Controller Example 2

A first multi-channel embodiment of a controller 208 similar to that shown in FIG. 3(b) is provided in FIG. 3(c), with a wavelength division multiplexing portion 350 and a sub-carrier modulation portion 352. This controller is tailored for the embodiment of the invention shown in FIG. 2, and therefore, is applicable to the controller referenced as 208. The controller 208 includes a plurality of optical fibers 320 as well as a plurality of wire connections 322. A gateway portion of the controller 324 is connected with the data system 102 to receive a signal for transmission 326. A portion of the signal for transmission 326 is provided to a 1×2 electrical/optical switch 328, while a small tapped portion of the signal for transmission 330 is provided to a photodiode 332 for conversion to an electrical signal 334. The electrical signal 334 and a reference signal 336 are provided to a logical AND gate 338 for comparison. Optionally, this check allows the controller 208 to compare the current transmission power to that required to push the optical signal across to the next hybrid wireless link 100. Alternatively, it allows the controller 208 to utilize a threshold power level derived from environmental information in order to control whether the laser portion 104 or the radio frequency portion 106 and 206 is employed. In the case where the sub-carrier modulation portion 352 is used, if the signal for transmission 326 is provided to the radio frequency portion 206, the signal for transmission 326 is passed through a photodiode 354 for conversion to an electrical signal 356. The electrical signal 356 is then passed to a channel filter 358, where the electrical signal 356 is filtered into a plurality Fₙ channels 360 en route to a radio frequency modem 342 in preparation for transmission by the radio portion 206. Using wavelength division modulation, the signal for transmission 326 includes a plurality of wavelength channels, and is passed to the wavelength division modulation portion 350, wherein a wavelength division demultiplexer 362 is used to break the signal for transmission 326 into the wavelength channels 364. A plurality of photodiodes 366 are used to convert the wavelength channels 364 into electrical signals 368, which are then sent to a radio frequency modem 342 in preparation for transmission by the radio portion 206. An opposite system corresponding to the wavelength division modulation portion 350 or the sub-carrier modulation portion 352 is employed in the receiving hybrid wireless link 100.

### Controller Example 3

A portion of a third embodiment of the controller 108 and 208 is provided in FIG. 3(d), wherein a latch system is employed in order to allow the signal for transmission 326 to be divided between the laser portion 104 and the radio frequency portion 106 and 206 in order to tailor the transmission optimally for particular atmospheric conditions. The portion of the controller 108 and 208 shown demonstrates how the small tapped portion of the signal for transmission 330 can be employed with the reference signal 336 in order to determine the portions of the signal for transmission 326 to be sent through the laser portion 104 and the radio frequency portion 106 and 206. The portion of the controller 108 and 208 receives a signal for transmission 326 from the gateway of the controller 324. The tapped portion of the signal for transmission 330 is converted to an electrical signal 334 by a photodiode 332, and is divided among a plurality Lₙ of latches 380, representing N different combinations of laser portion 104 and radio frequency portion 106 and 206 transmissions. Each of the latches 380 is configured to activate for a particular power level of the tapped portion of the signal for transmission 330. Upon activation, the latch 380 corresponding to the current power level sends a signal to a logic unit 382, typically an FPGA or ATM unit. The logic unit 382 generates an output signal 384 and a clock signal 386, which is sent to a multiplexer 388. This portion of the controller 108 and 208, via the latching mechanism, controls the portions of the signal for transmission 326 that are transmitted by the laser portion 104 and the radio frequency portion 106 and 206.

### Tandem Use of the Hybrid Wireless Link and Use in Network Topologies

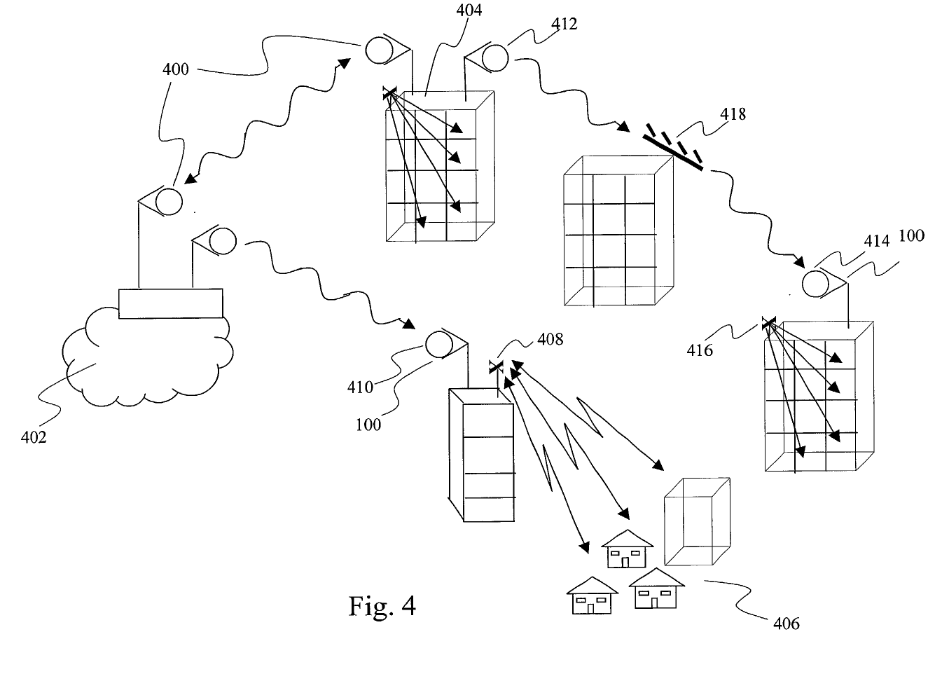

In addition to use as a protective and redundant system, the hybrid wireless link 100 of the present invention may be used in a manner that provides for an extension of typical radio frequency wireless networks. This embodiment is presented in FIG. 4, which shows the hybrid wireless link 100 receiving a signal from a laser link 400, which acts as a gateway to a backbone network 402 or to other systems such as a building 404. In many areas, radio frequency links do not have sufficient range to broadcast a signal to areas of interest. In the situation shown in FIG. 4, one goal is to transmit a signal from a backbone network 402 to a neighborhood of interest 406 located at a distance not reachable by typical radio frequency signals. The laser portion 408 of the hybrid wireless link 100 is used to send and receive longer-range signals to and from the backbone network 402, while the radio frequency portion 410 of the hybrid wireless link 100 is used to provide network access to the neighborhood of interest 406. Multiple antennas can be used by the radio frequency portion 410 to accommodate more users in the neighborhood of interest 406, as the laser portion 104 supports sufficient bandwidth to accommodate many times the aggregate bandwidth of many antennas. Another advantage of the laser portion 104, particularly in urban areas, is the ability to use an optical reflector 418 in order to get around buildings and other objects. This is shown in FIG. 4, where a reflector 418 is used to reflect a signal from a laser portion 412 to be received by another laser portion 414 in order to be re-broadcast by a radio frequency portion 416 to illuminate a building that would otherwise be out of range of the origin of the laser signal 400.

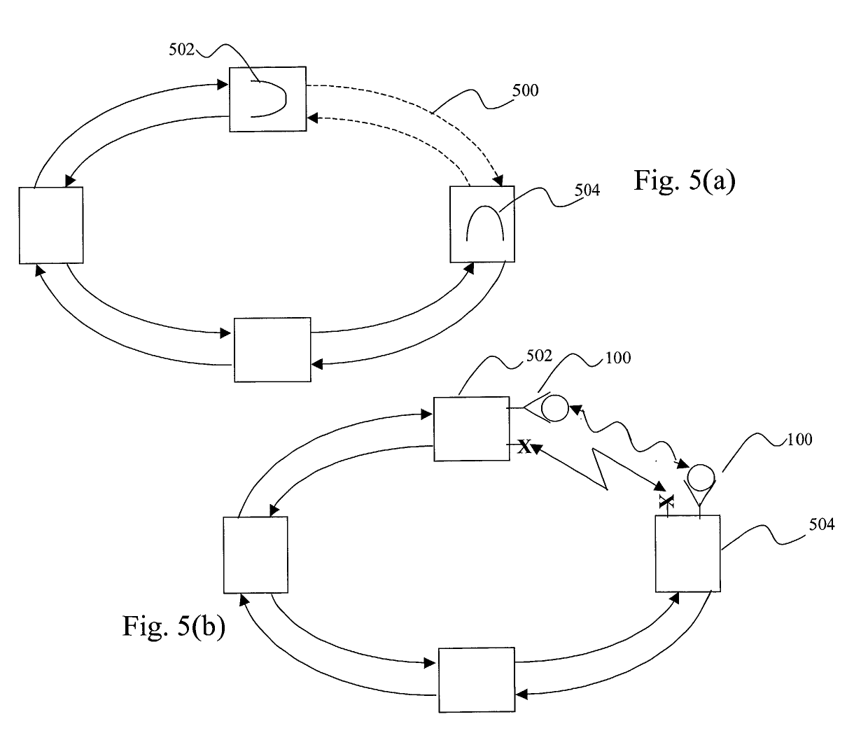

In addition to general use in networks and use as a tandem network component, the hybrid wireless link 100 can be used in support of ring network topologies. Current solutions to link breakages in ring networks require the re-routing of network communications in a u-shape so that the defective link is no longer required. This situation is shown in FIG. 5(a), wherein a link breakage 500 is re-routed at node 502 and node 504. The hybrid wireless link 100 of the present invention is used as shown in FIG. 5(b) in order to close a link breakage between nodes 502 and 504. The hybrid wireless link 100 thus allows the link breakage 500 to be repaired without re-routing the network communications. In addition to use in repairing link breakages 500, the hybrid wireless link 100 may also be used to branch out from a ring network.

What is claimed is:

1. A node incorporating hybrid radio frequency and optical wireless communication links, the node comprising:
a. at least one laser portion for transmitting data;
b. at least one radio frequency portion for transmitting data;
c. a data receiver for receiving data from a data source; and
d. a controller configured to receive data from a data source and connected with the laser portion and the radio frequency portion to allocate portions of the data to be transmitted through the laser portion and the radio frequency portion.

2. A node incorporating hybrid radio frequency and optical wireless communication links as set forth in claim 1, wherein the controller is configured as a binary switch such that the data is transmitted exclusively through either one of the laser portion and the radio frequency portion.

3. A node incorporating hybrid radio frequency and optical wireless communication links as set forth in claim 2, wherein the controller is configured to receive environmental information, and wherein the portions of the data to be transmitted through the laser portion and the radio frequency portion are adjusted by the controller based on the environmental information.

4. A node incorporating hybrid radio frequency and optical wireless communication links as set forth in claim 1, wherein the controller is configured to receive environmental information, and wherein the portions of the data to be transmitted through the laser portion and the radio frequency portion are adjusted by the controller based on the environmental information.

5. A node incorporating hybrid radio frequency and optical wireless communication links as set forth in claim 1, wherein the laser portion is configured to both transmit and receive and wherein the radio frequency portion is configured to both transmit and receive.

6. A node incorporating hybrid radio frequency and optical wireless communication links as set forth in claim 5, wherein the laser portion and the radio frequency portion are configured to transmit in multiple channels.

7. A node incorporating hybrid radio frequency and optical wireless communication links as set forth in claim 6, wherein the controller is configured to receive environmental information, and wherein the portions of the data to be transmitted through the laser portion and the radio frequency portion are adjusted by the controller based on the environmental information.

8. A node incorporating hybrid radio frequency and optical wireless communication links as set forth in claim 5, wherein the controller is configured as a binary switch such that the data is transmitted exclusively through either one of the laser portion and the radio frequency portion.

9. A node incorporating hybrid radio frequency and optical wireless communication links as set forth in claim 5, wherein the controller is configured to receive environmental information, and wherein the portions of the data to be transmitted through the laser portion and the radio frequency portion are adjusted by the controller based on the environmental information.

10. A node incorporating hybrid radio frequency and optical wireless communication links as set forth in claim 5, wherein the laser portion and the radio frequency portion have transmit and receive strengths, and wherein the controller is configured to monitor the transmit and receive strengths, wherein the portions of the data to be transmitted through the laser portion and the radio frequency portion are adjusted by the controller based on their transmit and receive strengths.

11. A node incorporating hybrid radio frequency and optical wireless communication links as set forth in claim 5, wherein the controller includes a plurality of latches and a logic device, wherein the plurality of latches and the logic device operate to provide adjustment levels for the portions of the data to be transmitted through the laser portion and the radio frequency portion.

12. A node incorporating hybrid radio frequency and optical wireless communication links as set forth in claim 11, wherein the laser portion and the radio frequency portion have aggregate transmit and receive strengths, and wherein the controller is configured to monitor the aggregate transmit and receive strengths, wherein the portions of the data to be transmitted through the laser portion and the radio frequency portion are adjusted by the controller based on their transmit and receive strengths.

13. A node incorporating hybrid radio frequency and optical wireless communication links as set forth in claim 11, wherein the laser portion and the radio frequency portion are configured to transmit in multiple channels.

14. A node incorporating hybrid radio frequency and optical wireless communication links as set forth in claim 13, wherein the each channel has a transmit and receive strength, and wherein the controller is configured to monitor the transmit and receive strength of each channel, wherein the channels of the data to be transmitted through the laser portion and the radio frequency portion are determined by the controller based on their transmit and receive strengths.

15. A node incorporating hybrid radio frequency and optical wireless communication links as set forth in claim 5, wherein the at least one laser portion and the at least one radio frequency portion are configured to transmit and receive in tandem, whereby the node may be configured to provide a hybrid serial link to permit tailored radio frequency or optical network connections.

16. A node incorporating hybrid radio frequency and optical wireless communication links as set forth in claim 15, wherein the laser portion and the radio frequency portion are configured to transmit and receive in multiple channels.

17. A node incorporating hybrid radio frequency and optical wireless communication links as set forth in claim 15, wherein an optical reflector is used to deflect transmissions from the laser portion in order to work around fixed objects in the environment, whereby the node may be used to extend a network and the laser portion can maintain communication without the need for a strict line-of-site connection.

18. A network incorporating hybrid radio frequency and optical wireless communication links, said network comprising a plurality of nodes, each node including:
a. at least one laser portion for transmitting data;
b. at least one radio frequency portion for transmitting data;
c. a data receiver for receiving data from a data source; and
d. a controller configured to receive data from a data source and connected with the laser portion and the radio frequency portion to allocate portions of the data to be transmitted through the laser portion and the radio frequency portion.

19. A network incorporating hybrid radio frequency and optical wireless communication links as set forth in claim 18, wherein the controller of each node is configured as a binary switch such that the data is transmitted exclusively through either one of the laser portion or the radio frequency portion.

20. A network incorporating hybrid radio frequency and optical wireless communication links as set forth in claim 19, wherein the controller of each node is configured to receive environmental information, and wherein the portions of the data to be transmitted through the laser portion and the radio frequency portion are adjusted by the controller based on the environmental information.

21. A network incorporating hybrid radio frequency and optical wireless communication links as set forth in claim 18, wherein the controller is configured to receive environmental information, and wherein the portions of the data to be transmitted through the laser portion and the radio frequency portion are adjusted by the controller based on the environmental information.

22. A network incorporating hybrid radio frequency and optical wireless communication links as set forth in claim 18, wherein the laser portion and the radio frequency portion of each node have transmit and receive strengths, and wherein the controller is configured to monitor the transmit and receive strengths, wherein the portions of the data to be transmitted through the laser portion and the radio frequency portion are adjusted by the controller based on their transmit and receive strengths.

23. A network incorporating hybrid radio frequency and optical wireless communication links as set forth in claim 18, wherein the laser portion and the radio frequency portion of each node are configured to transmit in multiple channels.

24. A network incorporating hybrid radio frequency and optical wireless communication links as set forth in claim 18, wherein the at least one laser portion and the at least one radio frequency portion are configured to transmit and receive in tandem, whereby the node may be configured to provide a hybrid serial link to permit tailored radio frequency or optical network connections.

25. A network incorporating hybrid radio frequency and optical wireless communication links as set forth in claim 18, wherein at least a portion of the network is configured with a ring topology.

26. A network incorporating hybrid radio frequency and optical wireless communication links as set forth in claim 25, wherein at least a portion of the network is configured as a SONET ring.

27. A network incorporating hybrid radio frequency and optical wireless communication links as set forth in claim 23, wherein at least a portion of the network is configured with a ring topology.

28. A network incorporating hybrid radio frequency and optical wireless communication links as set forth in claim 27, wherein at least a portion of the network is configured as a SONET ring.
